(19) United States
(12) Patent Application Publication
(10) Pub. No.: US 2007/0296229 A1
(43) Pub. Date: Dec. 27, 2007

(54) Grappling system

(75) Inventors: Mark A. Chauvin, Houma, LA (US); Michael Mire, Kenner, LA (US); Matthew G. Mecklin, Two Harbors, MN (US); Clayton Sederberg, Duluth, MN (US); Jaret L. Wilkins, Duluth, MN (US)

Correspondence Address: PILLSBURY WINTHROP SHAW PITTMAN, LLP, P.O. BOX 10500, MCLEAN, VA, 22102, US

(73) Assignees: The Stanley Works, New Britain, CT (US); Gulfstream Services, Inc., Houma, LA (US)

(21) Appl. No.: 11/473,322

(22) Filed: Jun. 23, 2006

(51) Int. Cl. B66C 1/28

(52) U.S. Cl. 294/81.61

(57) ABSTRACT

A grappling system includes a frame and a plurality of grapples supported by the frame. The grappling system may be suspended from a crane-and-submerged into a body of water to grip and manipulate an underwater object such as a portion of a decommissioned oil platform.

### BACKGROUND OF THE INVENTION

1. Field of the Invention

The present invention relates to powered grapples and methods of using such powered grapples in underwater environments.

2. Description of Related Art

Dismantling decommissioned oil platforms requires breaking the oil platform into a plurality of pieces (e.g., via explosives, torches, saws, etc.), retrieving the severed pieces from the sea floor, and transporting the severed pieces to land or another suitable resting spot on the sea floor (e.g., a designated artificial reef area; an area where the severed piece is deep enough not to interfere with ship navigation).

Retrieval of severed pieces has conventionally required hoisting the pieces up from the sea floor using cable slings that a human diver or remotely operated vehicle (ROV) attaches to the piece on the sea floor. Attaching the sling to the severed piece frequently requires the diver or ROV to dig into the sea floor silt below and around the severed piece to wrap the cable sling around the piece. This work is dangerous and time consuming.

### BRIEF SUMMARY OF THE INVENTION

An aspect of one or more embodiments of the present invention provides a method of efficiently and safely retrieving/moving pieces of decommissioned oil platforms through the use of a grappling system that quickly and efficiently grips and moves severed portions of the oil platform. This method of manipulating underwater objects may reduce or eliminate hazardous diver time, thereby increasing safety. The grappling system may include a frame and two spaced apart grapples. The spacing of the grapples facilitates the secure and safe gripping of elongated work pieces such as sections of pipe and/or sections of a decommissioned oil platform.

Another aspect of one or more embodiments of the present invention includes a grappling system that includes a frame and first and second grapples supported by the frame. The grapples are spaced from each other. Each grapple includes first and second jaws operatively connected with each other for relative movement between a gripping position and a released position. Each grapple also includes an actuator (e.g., one or more hydraulic cylinders) for powered movement of the jaws from their released position to their gripping position.

According to a further aspect of one or more of these embodiments, the actuators of the first and second grapples are independently operable such that the first and second grapples may be independently moved from their released position to their gripping position.

According to a further aspect of one or more embodiments of the present invention, the first and second grapples are supported by the frame via spaced apart first and second connections, respectively. A distance between the first and second connections may be selectively changed based on at least one physical parameter of an object to be gripped by the grappling system (e.g., to accommodate the length of the object to be gripped).

According to further aspects of one or more embodiments of the present invention, the grapples may connect to the frame via various movable connections (e.g., universal joints, rotational couplers, single yokes, tracked-connections). One or more of these movable connections may be powered (e.g., via suitable actuators) or free-moving. If free-moving, a remotely operated vehicle may be used to move the grapples relative to the frame about the movable connection(s) to position the grapples around an object to be gripped.

According to a further aspect of one or more embodiments of the present invention, a support cable attaches to the frame and supports the weight of the frame and grapples. A crane may support the cable so as to facilitate controlled movement of the grappling system via the crane. The frame and grapples may be submerged in a body of water to grip and move a submerged object.

According to a further aspect of one or more embodiments of the present invention, a shears is supported by the frame. The shears may be used to sever a piece of an object from a remainder of the object such that the grappling system can move the severed piece to a desired location.

The grapples may include movable and/or detachable inserts that selectively reduce a size of an opening formed between the first and second jaws of the grapples. Such inserts may facilitate gripping and moving of smaller objects. An actuator such as a hydraulic cylinder may extend between the insert and associated grapple jaw to facilitate selective positioning and locking of the insert relative to its associated jaw.

According to a further aspect of one or more embodiments of the present invention, the grappling system includes a power supply operatively connected to the actuator of the first grapple to provide gripping power to the actuator of the first grapple. The grappling system also includes a grip locking mechanism constructed and arranged such that when the first grapple is moved into its gripping position, the locking mechanism locks the first grapple in its gripping position even if the first actuator is operatively disconnected from the power supply. The grappling system may also include a release mechanism for selectively disabling the grip locking mechanism to release the grapple from a gripped object.

According to a further aspect of one or more embodiments of the present invention, opposing inner surfaces of the first and second jaws, respectively, form depressions that bulge away from the opposing jaw.

Another aspect of one or more embodiments of the present invention provides a method of using the above-described grappling system to manipulate an underwater object. The method includes submerging the grappling system in a body of water, gripping the object with the first and second grapples, and moving the grappling system so as to move the object.

According to a further aspect of one or more of these embodiments, the object is a portion of a decommissioned oil platform. The object may be heavy (e.g., over 5,000 lbs.) and elongated (e.g., over 20 feet long).

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a front view of a grappling system according to an embodiment of the present invention;

FIG. 2 is a side view of the grappling system in FIG. 1;

FIG. 3 is a perspective view of a grapple according to an alternative embodiment of the present invention;

FIG. 4 illustrates the use of the grappling system in FIG. 1 to retrieve a severed piece of a decommissioned oil platform;

FIG. 5 is a partially disassembled side view of a grapple of the grappling system in FIG. 1;

FIG. 6 is a schematic hydraulic diagram for the grapple in FIG. 5;

FIG. 7A is a side view of an adjustable grapple jaw according to an alternative embodiment of the present invention in a retracted position;

FIG. 7B is a side view of the grapple jaw in FIG. 7A in an extended position;

FIG. 8 is a front view of a grappling system according to an alternative embodiment of the present invention;

FIG. 9 is a front view of a grappling system according to an alternative embodiment of the present invention;

FIG. 10 is a front view of a grappling system according to an alternative embodiment of the present invention; and

FIG. 11 is a front view of a grappling system according to an alternative embodiment of the present invention.

### DETAILED DESCRIPTION OF EMBODIMENTS OF THE INVENTION

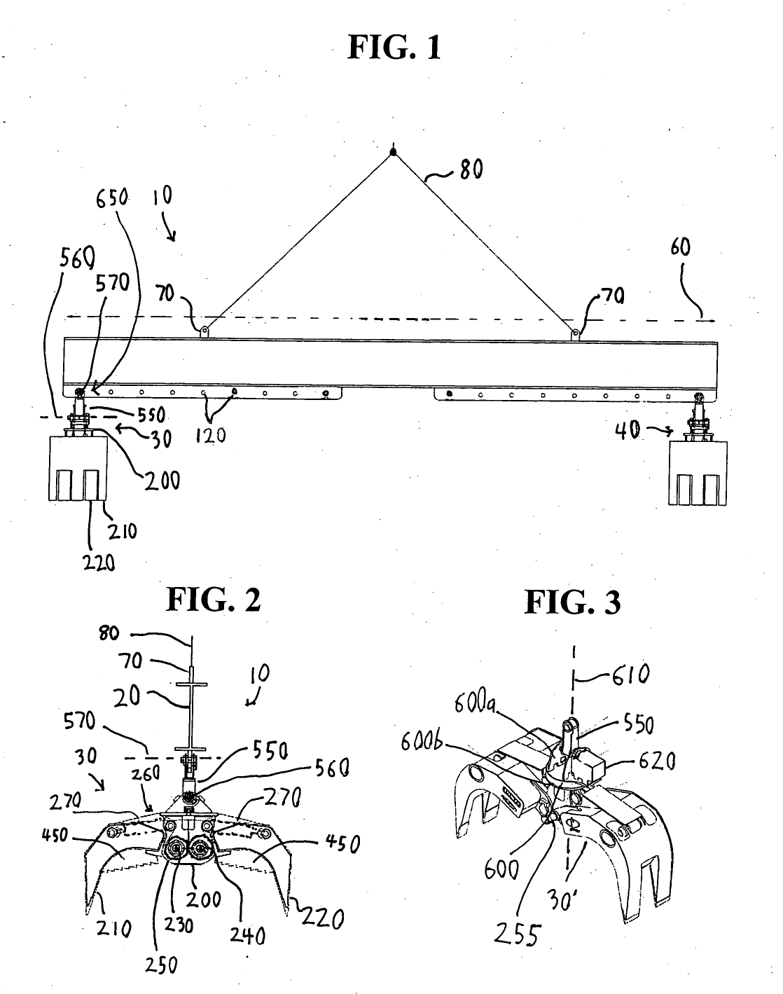

FIGS. 1, 2, and 4-6 illustrate a grappling system 10 according to an embodiment of the present invention. As shown in FIG. 1, the grappling system 10 comprises a frame 20 and two grapples 30, 40 supported by the frame 20.

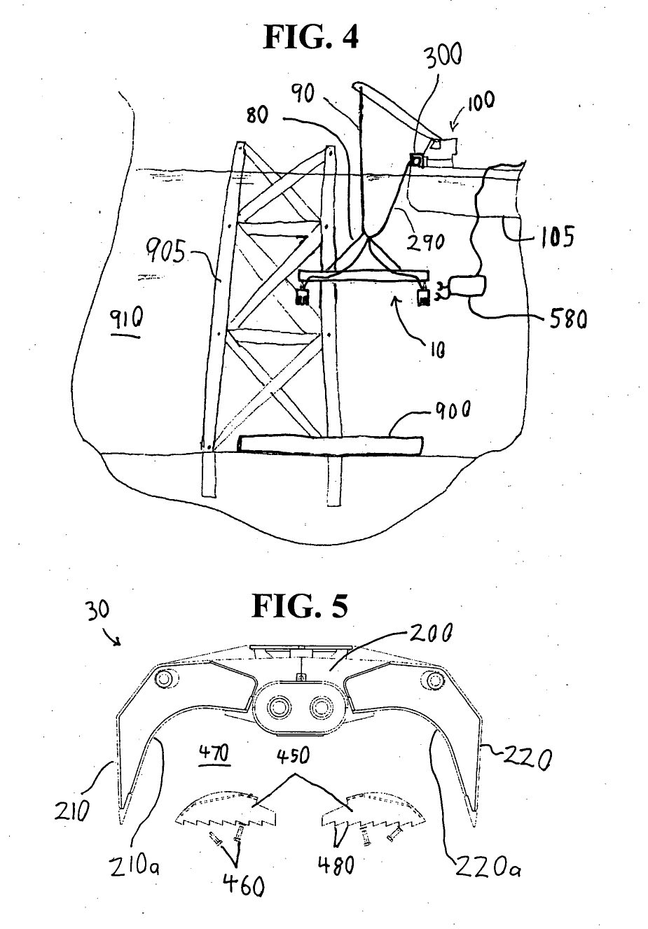

As shown in FIG. 1, the frame 20 is elongated along its longitudinal axis 60. According to various embodiments of the present invention, the frame 20 is at least 20 feet long, at least 30 feet long, and/or about 40 feet long. The frame 20 includes mounting lugs 70 for mounting the frame 20 to a cable Y-yoke 80. As shown in FIG. 4, the Y-yoke facilitates connection of the grappling system 10 to a cable 90 of a crane 100 or other machine (e.g., winch, hoist) that is mounted on a vessel 105 (e.g., a ship, barge, oil platform, submarine, helicopter, etc.). As shown in FIG. 1, the frame 20 includes a plurality of mounting holes 120 that define grapple support points for the grapples 30, 40, as discussed below. The mounting holes 120 are longitudinally spaced from each other (e.g., one every two feet). The mounting holes 120 may be replaced by any other suitable grapple support points without deviating from the scope of the present invention (e.g., hooks, protrusions, or other structure that the grapples may positively attach to).

In the illustrated embodiment, the frame 20 primarily comprises an I-beam (e.g., a commercially available spreader bar such as those manufactured by Versabar, Inc.), but may alternatively comprise any other suitable structure without deviating from the scope of the present invention (e.g., a truss, with cross-braces).

As shown in FIG. 1, the grapples 30, 40 mount to selected mounting holes 120 of the frame 20 and are longitudinally spaced from each other. In the illustrated embodiment, the grapples 30, 40 are similar to each other, but may alternatively be structurally different from each other (e.g., one grapple being larger than the other; one grapple having more and/or different degrees of freedom of movement than the other; symmetric or asymmetric orientations of the grapples 30, 40). Accordingly, only the grapple 30 is described in detail.

As shown in FIG. 2, the grapple 30 comprises a grapple frame 200. Two jaws 210, 220 pivotally connect to the frame 200 for relative pivotal movement about grapple jaw axes 230, 240. The jaws 210, 220 are linked to each other via timing gears 250 so that the jaws 210, 220 synchronously move between a released position (shown in FIG. 2) and a gripping position that grips an object disposed between the jaws 210, 220. As shown in the embodiment in FIG. 3, a timing link 255 may alternatively extend between the jaws to synchronize their movement. Moreover, a timing mechanism may be omitted entirely without deviating from the scope of the present invention.

As shown in FIG. 1, the jaw 210 includes three tines that mesh with the two tines of the jaw 220. However, greater or fewer meshing tines may be included without deviating from the scope of the present invention. For example, the jaws may each include one tine that is offset from the tine of the opposing jaw to enable the tines to bypass each other as the grapple closes. Alternatively, the grapple 30 may comprise a butt grapple whose jaws are aligned and abut at their tips when the grapple is closed.

In the illustrated embodiment, the three tined jaws 210 of both grapples 30, 40 are disposed on the front side of the grappling system 10 shown in FIG. 1. However, the grapple 40 could be pivoted 180 degrees such that its two tined jaw 220 is disposed on the front side of the grappling system 10. Such asymmetric orientations of the grapples 30, 40 may improve the weight distribution of the grappling system 10 to centralize the system's center of gravity.

As shown in FIG. 5, inner surfaces 210a, 220a of the jaws 210, 220 face each other and form depressions that bulge concavely away from each other. While the illustrated depressions are smoothly concave, the depressions may alternatively comprise a variety of other suitable shapes (e.g., V-shape with an apex that points away from the opposing jaw; compound curvature; polygonal shape; combination of lines and curves, etc.). The space between the facing surfaces 210a, 220a defines the opening 470 of the grapple 30. As the jaws 210, 220 move toward their gripping position, the tips of the tines of the jaws 210, 220 move past each other such that the opening 470 has a closed perimeter, thereby surrounding any object disposed within the opening 470.

An actuator 260 operatively extends between the jaws 210, 220 to selectively move the jaws 210, 220 between their gripping and released positions. In the illustrated embodiment, the actuator 260 comprises two dual-action hydraulic cylinders 270 that operatively extend between the grapple frame 200 and the jaws 210, 220, respectively. While the illustrated actuator 260 comprises two hydraulic cylinders 270, the actuator 260 may alternatively comprise any other suitable actuator without deviating from the scope of the present invention (e.g., a single hydraulic cylinder that extends between the jaws 210, 220, an electric linear or rotational actuator, a single cylinder that selectively moves a moving jaw relative to a fixed jaw, etc.).

As shown in FIG. 4, the actuators 260 of the grapples 30, 40 operatively connect via hydraulic hoses 290 to a hydraulic power pack 300 located on the vessel 105. The power pack 300 is user-operated and selectively provides hydraulic pressure to the actuators 260 to open and close the grapples 30, 40. The hydraulic hoses 290 are fed to the grappling system 10 via hose reels that take up and let out the hoses 290 as the crane 100 raises and lowers the grappling system 10. The hoses 290 may be hundreds or even thousands of feet long (e.g., 3,000 to 7,000 feet) to facilitate positioning the grappling system 10 in deep water.

The power pack 300 may comprise discrete power pack units, one for each grapple 30, 40. Each power pack unit may be operable and powered independently of the other power pack unit. Accordingly, if one of the power pack units fails, both grapples 30, 40 may be connected to the other power pack unit, thereby providing a back-up system. As discussed below, the power pack 300 may additionally be used to power various other hydraulically powered components of the grappling system 10 or another grappling system. The power pack 300 preferably includes valves and fluid paths to facilitate the selective provision of hydraulic pressure to any one of a plurality of hoses 290.

As described in detail below, the grapple 30 includes safety lock and safety release mechanisms that are designed to function even in the absence of hydraulic pressure from the power pack 300 (e.g., in case the power pack 300 loses power or the hydraulic lines 290 are severed). The safety lock mechanism locks the grapple 30 in its gripping position when the grapple 30 is moved into its gripping position to securely grip an object even if hydraulic power is lost. Conversely, the safety release mechanism provides a mechanism for moving the grapple 30 into its released position to free the grapple 30 from a gripped object if hydraulic power from the power pack 300 is not available.

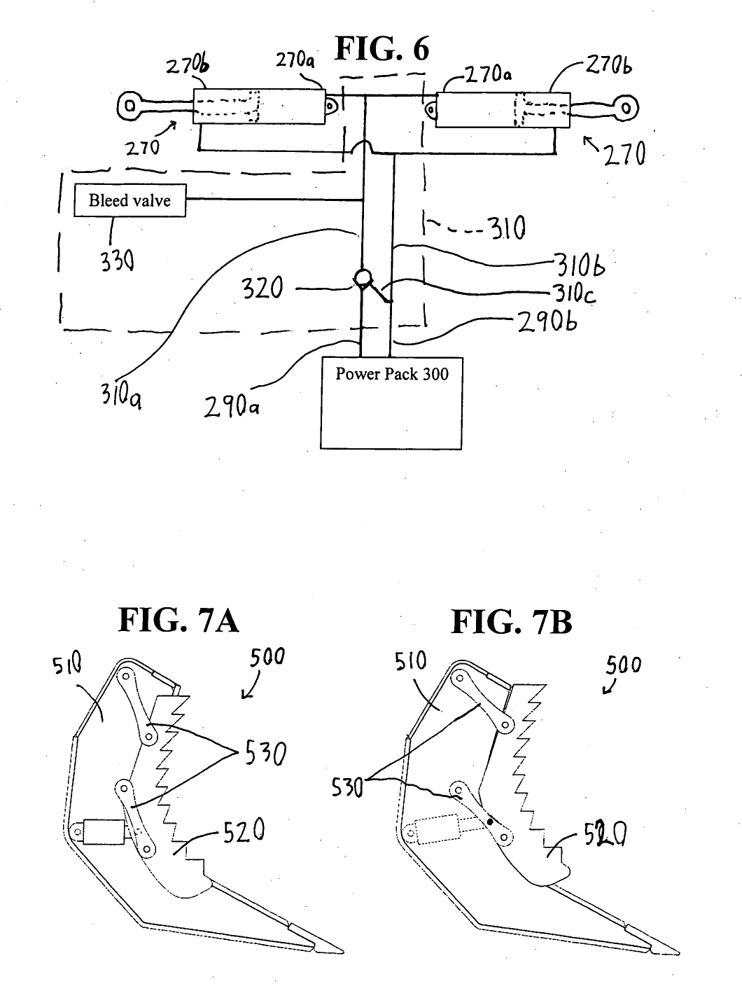

As shown in FIG. 6, the cylinders 270 of the grapple 30 fluidly connect to the power pack 300 via a manifold 310 that includes various bores to hydraulically connect the cylinders 270 to the hoses 290. The hydraulic hoses 290 include a gripping hose 290a and a release hose 290b. The manifold 310 includes a grapple close fluid path 310a that fluidly connects the gripping hose 290a to the bore sides 270a (i.e., the extension sides) of the cylinder 270. A check valve 320 is disposed in the fluid path 310a. The check valve 320 allows fluid flow from the hose 290a toward the cylinders 270 but normally prevents fluid flow in the opposite direction. A normally-closed bleed valve 330 fluidly connects to the fluid path 310a between the check valve 320 and the bore sides 270a of the cylinders 270. The bleed valve 330 includes a manually openable release structure (e.g., a bolt head that must be moved 180 degrees to open the bleed valve 330). The manifold 310 also includes a grapple open fluid path 310b that fluidly connects the release hose 290b to the rod sides 270b (i.e., the retraction sides) of the cylinder 270. A control signal path 310c extends from the grapple open fluid path 310b to a the check valve 320. The check valve 320 is constructed to open when a sensed pressure in the control signal path 310c exceeds a predetermined value (e.g., about ⅓ of the operating pressure of the cylinders 270).

Hereinafter, operation of the safety lock and release mechanisms is described with reference to FIG. 6. To move the grapple 30 into its gripping position, the power pack 300 provides hydraulic pressure to the hose 290a, which causes hydraulic fluid to flow through the check valve 320 and fluid path 310a into the bore sides 270a of the cylinders 270. Even if the power pack 300 loses power or the hose 290a is severed, the check valve 320 normally prevents hydraulic fluid from flowing out of the cylinders 270, thereby locking the cylinders 270 and associated grapple 30 in their extended, gripping positions. The locking mechanism ensures that an object gripped by the grapple 30 remains safely gripped even if hydraulic power to the grapple 30 is lost.

The check valve 320 may also provide overpressure relief for the grapple 30. If pressure in the bore sides of the cylinders 270 exceeds a predetermined safe pressure (e.g., 5000 psi), the check valve 320 opens to allow fluid to flow out of the cylinders 270. The predetermined safe pressure is preferably smaller than a cylinder 270 pressure that might deform or break any structural component of the grapple 30.

To move the grapple 30 into its released position, the power pack 300 provides hydraulic pressure to the hose 290b, which causes hydraulic fluid to flow through the fluid path 310b and into the rod sides 270b of the cylinders 270. Pressurizing the hose 290b also pressurizes the control signal path 310c, which opens the check valve 320 to allow hydraulic fluid in the bore sides of the cylinders 270 to drain back to the power pack 300.

Hereinafter, the safety release mechanism is described with reference to FIG. 6. If the grapple 30 is in its gripping position and hydraulic pressure to the release hose 290b is lost (e.g., via loss of power to the power pack 300 or a failure of the hose 290b), the check valve 320 prevents the grapple 30 from opening. To override this safety locking mechanism, the bleed valve 330 can be opened, thereby venting the bore sides 270a of the cylinders 270 and allowing the grapple 30 to move into its released position. If the grapple 30 is underwater when the safety release mechanism is to be used, the bleed valve 330 may be opened by a diver or an ROV from a safe position away from an object gripped by the grapple 30.

According to an alternative embodiment of the present invention, the power pack 300 is mounted to the frame 20 of the grappling system 10 and is designed to be operated underwater. The use of such an underwater power pack may eliminate the need to run long lengths of hydraulic hose from the vessel 105 to the grappling system 10.

The illustrated hydraulic power pack 300 utilizes hydraulic fluid as the operating fluid. However, a variety of other operating fluids may alternatively be used without deviating from the scope of the present invention (e.g., fresh water, ambient water in the body of water in which the grappling system 10 is operated).

The relative placement of the pivotal connections between the cylinders 270, grapple frame 200, and jaws 210, 220 causes the mechanical advantage of the hydraulic cylinders 270 to vary over the pivotal range of the jaws 210, 220 (i.e., a ratio of the linear extension speed of the cylinders 270 to the pivotal closing speed of the jaws 210, 220 varies as a function of the pivotal position of the jaws 210, 220). It is desirable to maximize the mechanical advantage of the cylinders 270 at a jaw 210, 220 pivotal position that corresponds to the gripping position for an object to be gripped. As shown in FIG. 5, the gripping position occurs when an opening 470 defined between the jaws 210, 220 is roughly the same size as the size of the object to be gripped. Maximizing the mechanical advantage at this gripping position maximizes the gripping force of the grapple 30 and ensures that the grapple 30 safely and securely grips the object. The shape and size of the jaws 210, 220 (as shown in FIG. 5) are designed to maximize gripping force when gripping larger diameter objects. Consequently, when smaller objects are to be gripped using the jaws 210, 220, the jaws 210, 220 close further before reaching their gripping position, and the mechanical advantage of the cylinders 270 reduces, thereby reducing the gripping force applied to such smaller objects. As shown in FIGS. 2 and 5, to increase the gripping force applied to such smaller objects, inserts 450 may be removably attached to the inside of the jaws 210, 220 via bolts 460 (FIG. 5) or other suitable fasteners (e.g., pins, clamps, screws, etc.). An insert 450 may be provided for each tine of the each jaw 210, 220. The inserts are preferably sized and shaped to reduce the size of the opening 470 between the jaws 210, 220 and cause the jaws 210, 220 to grip smaller objects at a pivotal position that roughly corresponds to the pivotal position in which the insertless jaws 210, 220 grip larger objects. The inserts 450 therefore increase the gripping force applied to smaller objects. As shown in FIG. 5, the inserts 450 may include teeth 480 or other surface features (e.g., ribs, protrusions, spikes, etc.) to further improve the grapple's grip on smaller objects. To facilitate further fine tuning of the grapple opening 470 relative to the size of the object to be gripped, spacers (not shown) may be disposed between the inserts 450 and the jaws 210, 220 to further selectively reduce the opening 470 size.

FIGS. 7A and 7B illustrate an adjustable jaw assembly 500 according to an alternative embodiment of the present invention. The jaw assembly 500 may replace the jaw 210 or 220 without deviating from the scope of the present invention. The jaw assembly 500 includes a jaw 510 that is similar to the jaws 210, 220. The jaw assembly 500 also includes an insert 520 that movably connects to the jaw 510 for relative movement between a retracted position (FIG. 7A) and one or more extended positions (FIG. 7B). In the illustrated embodiment, the movable connection comprises a four-bar linkage 530. According to alternative embodiments, the movable connection comprises a simple pivotal connection, a sliding linear or curvilinear connection, or any other type of suitable movable connection.

The jaw assembly 500 also includes a hydraulic cylinder 540 (or other suitable actuator) that operatively extends between the jaw 510 and the insert 520 to control the position of the insert 520. The cylinder 540 connects to the power pack 300 via suitable hydraulic line(s) for selective powered actuation of the cylinder 540. The cylinder 540 provides proportional control of the insert 520 so as to enable the insert 520 to be placed in a variety of extended positions. The jaw assembly 500 may include a check valve similar to the check valve 320 to lock the cylinder 540 and insert 520 into a desired extended position. Actuation of the cylinder 540 enables the jaw assembly 500 to be adjusted to precisely match an opening size between the jaws to a size of an object to be gripped and maximize the gripping power of the grapple.

While the embodiment illustrated in FIGS. 7A and 7B utilizes a hydraulic cylinder to position and lock the insert 520 into a desired position, a variety of other mechanisms may alternatively be used to move the insert 520 between extended and retracted positions and/or lock the insert 520 in a desired position. For example, the insert 520 may be freely manually movable between its retracted and one or more extended positions. If such movement is done under water, it may be done by a diver or an ROV. A locking mechanism may be provided by pins and aligned holes in the four bar linkage 530, the insert 520, and/or the jaw 510. A diver, ROV, or other mechanism may place such pins in the aligned holes to lock the insert 520 in a desired position.

Returning to the embodiment illustrated in FIGS. 1 and 2, the grapple 30 connects to the frame 20 via a universal joint 550 (e.g., a double yoke joint) that enables the grapple 30 to pivot relative to the frame 20 about orthogonal axes 560, 570. The axis 560 is parallel to the axes 60, 230, 240. The axis 570 is perpendicular to the axes 60, 230, 240, 560. The universal joint 550 enables the grapple 30 to be pivoted to better fit around an object to be gripped. In the illustrated embodiment, the grapple 30 is freely pivotal about the axes 560, 570 (within a range of pivotal movement) so that an ROV 580 (see FIG. 4) can pivot the grapple 30 into a desired position. The pivotal range of the universal joint 550 is limited (e.g., permitting the grapples 30, 40 to pivot 45 degrees in either direction relative to either axis 560, 570). The universal joint 550 may also enable the grapple to naturally find a position in which the object to be gripped is disposed between the jaws 210, 220 as the crane 100 lowers the grapple 30 onto the object. According to an alternative embodiment of the present invention, actuator(s) extend between the frame 20 and grapple 30 to provide selective positive pivotal movement of the grapple relative to the axes 560, 570.

While a universal joint 550 is utilized to connect the grapple 30 to the frame 20 in the illustrated grappling system 10, various other joints may alternatively be used without deviating from the scope of the present invention. For example, as explained below with respect to the grappling systems 1000, 1200, a single-yoke joint that permits relative pivotal movement between the grapple 30 and frame 20 about just one axis may be used. Alternatively, the frame 200 of the grapple 30 may rigidly connect to the frame 20 without deviating from the scope of the present invention.

As shown in FIG. 1, the grapple 30 connects to the frame 20 via a pinned pivotal connection 650 that forms a part of the universal joint 550 and facilitates pivotal movement of the grapple 30 about the axis 570. The pivotal connection 650 utilizes a selected mounting hole 120 that is coaxial with a pin of the pivotal connection 650. The grapples 30, 40 may be moved closer to each other or further from each other by moving this pivotal connect 650 to mounting holes 120 that are spaced closer or further from each other. Typically, the grapples 30, 40 are attached to mounting holes 120 that are disposed an equal distance from a longitudinal center of the frame 20. Such spacing facilitates even loading of an object that is centrally disposed below the frame 20. However, as shown in the embodiment in FIG. 9, the grapples 30′, 40′ may alternatively be disposed asymmetrically relative to the center of the frame 20 without deviating from the scope of the present invention.

Hereinafter, use of the grappling system 10 is described with reference to FIG. 4. With the grappling system 10 above water, the grapples 30, 40 are moved to desired mounting holes 120 to provide a spacing that accommodates a work piece 900 to be gripped (e.g., a severed piece of a decommissioned oil platform 905, a conductor pipe for the transportation of oil, a length of natural gas pipeline, a log, an I-beam, etc.). The inserts 450 may be attached to the jaws 210, 220 or removed from the jaws 210, 220 to match the diameter/size of the work piece 900. The crane 100 the lowers grappling system 10 into a body of water 910 and positions the grappling system 10 in the vicinity of the work piece 900.

The ROV 580 and crane 100 then work together to position the open grapples 30, 40 around the work piece 900. The ROV 580 may include several small articulable arms, a plurality of tools (e.g., wrenches, ratchets, etc.), lights, and video cameras. The crane 100 performs the gross movement of the grappling system (e.g., up/down/horizontal movement) while the ROV 580 carries out the finer translational adjustment of the grappling system 10. The ROV 580 also selectively pivots the grappling system about a vertical axis defined by the cable 90. Above-water operators of the ROV use the video images and various controllers (e.g., joysticks) to remotely observe and manipulate the ROV 580 in order to position the grappling system 10. The crane 100 operator may also view the ROV's video feed to help the crane operator control the grappling system 10 with the crane 100.

With the grapples 30, 40 properly positioned around the work piece 900, the power pack 300 is used to move the grapples 30, 40 into their gripping positions to grip the work piece 900. The crane 100 then moves the grappling system 10 and gripped work piece 900 to a desired location above the water (e.g., on a barge for further transportation) or below the water (e.g., to a location further away from the oil platform 905, to a location in deeper water, etc.). The power pack 300 then releases the grapples 30, 40 to release the work piece 900 in the desired location.

According to an alternative method of use, the ROV 580 and crane 100 first focus on positioning the grapple 30 around the work piece 900. The grapple 30 then grips the work piece 900. With the grappling system 10 gripping the work piece 900 with the grapple 30, it may be easier to maneuver and position the grapple 40 around the work piece by using the grapple 30 as a fulcrum/pivot point. The grapple 40 is then closed to grip the work piece 900.

Sequential gripping by the grapple 30 and then the grapple 40 is particularly well suited for gripping a work piece 900 that is disposed at an angle relative to horizontal (e.g., 30 degrees). In such a scenario, the grapple 30 is used to first grip a higher portion of the work piece 900. The grapple 30 then becomes the fulcrum as the grappling system 10 is pivoted and lowered down to engage the grapple 40 with a lower portion of the work piece 900.

According to various embodiments of the present invention, the work piece 900 comprises a piece of a decommissioned oil platform 905. The grappling system 10 may grip a work piece 900 before or after it is severed from the remainder of the oil platform. Gripping the work piece 900 prior to severing the work piece 900 from the platform 905 may help stabilize the work piece 900 during severing and reduce stress on the tool being used to sever the work piece 900. Moreover, gripping the work piece 900 before severing it from the remainder of the oil platform 905 may avoid the need to move the grappling system 10 down to the sea floor to retrieve the sunken severed work piece 900.

FIG. 9 illustrates a grappling system 10′ according to an alternative embodiment of the present invention. The grappling system 10′ is generally similar to the grappling system 10. Accordingly, a redundant description of redundant components is omitted. The grappling system 10′ differs from the grappling system 10 in that a rotational coupler 600 is provided between the grapple 30′ and the frame 20 in addition to a universal joint 550. As shown in FIG. 3, the rotational coupler 600 comprises upper and lower halves 600a, 600b that rotationally engage each other via a turn table bearing. The upper half 600a attaches to the universal joint 550 or the frame 20. The lower half 600b attaches to the grapple 30′ (or a universal joint 550 disposed between the rotational coupler 600 and the grapple 30′). The rotational coupler 600 enables the grapple 30′ to rotate relative to the frame 20 about a rotational coupler axis 610 that is perpendicular to the axis 560, 570 of the universal joint 550. The illustrated rotational coupler 600 is a knock-around coupler that permits free rotational movement of the grapple 30′. The ROV 580 may physically move the grapple 30′ about the axis 610. The grapple 30′ may naturally pivot about the axis 610 to settle around an object to be gripped as the crane 100 lowers the grapple 30′ onto the object.

While the illustrated rotational coupler 600 is freely rotatable, a rotational actuator may alternatively be provided to facilitate controlled rotational positioning of the grapple 30′ about the axis 610. For example, as shown in shown in FIG. 3, a rotational actuator 620 may be operatively connected to the rotational coupler 600. The rotational actuator 620 comprises a hydraulic motor mounted to the upper half 600a of the rotational coupler 600. A pinion attached to the shaft of the hydraulic motor meshes with a gear on the lower half 600b such that operation of the motor pivots the grapple 30′ relative to the frame 20 about the axis 610. The motor connects to the power pack 300 via suitable hydraulic lines. While the illustrated rotational actuator 620 comprises a hydraulic motor with a pinion and gear, the rotational actuator may alternatively comprise any other suitable rotational actuator without deviating from the scope of the present invention (e.g., electric motor with a gear transmission and control wires extending up to the vessel 105, crane 100, and/or power pack 300).

As shown in FIG. 9, a thruster 630 is supported by the frame 20 and is disposed at or near a longitudinal end of the frame 20. The thruster 630 includes a propeller and motor to propel the frame 20 relative to the surrounding body of water. The illustrated thruster 630 is oriented to provide a force in a vector that is perpendicular, to and spaced from an axis 640 of the cable 90. Accordingly, operation of the thruster 630 tends to pivot the grappling system 10′ about the vertically extending axis 640. Additional thruster(s) may be provided to propel the frame 20 along additional selected vectors (e.g., vectors that tend to move the grappling system 20 in a desired horizontal direction (e.g., in a horizontal direction that is parallel or perpendicular to a longitudinal axis 650 of the frame 20). Additional thrusters may be provided on the grapples 30′, 40′, themselves, to translate and/or pivot the grapples 30, 40 relative to the frame 20. Such thrusters may provide sufficiently fine movement of the grappling system 10′ that they can position the grappling system 10′ around a desired work piece without additional assistance from the ROV 580 or a diver. Video cameras (not shown) may be mounted to the grappling system 10′ or cables 80, 90 to provide a remote operator (e.g., the crane 100 operator and/or the operator of the power pack 300) with a live view of the grappling system 10′ and work piece 900 to facilitate precise positioning of the grapples 30, 40 relative to the work piece 900.

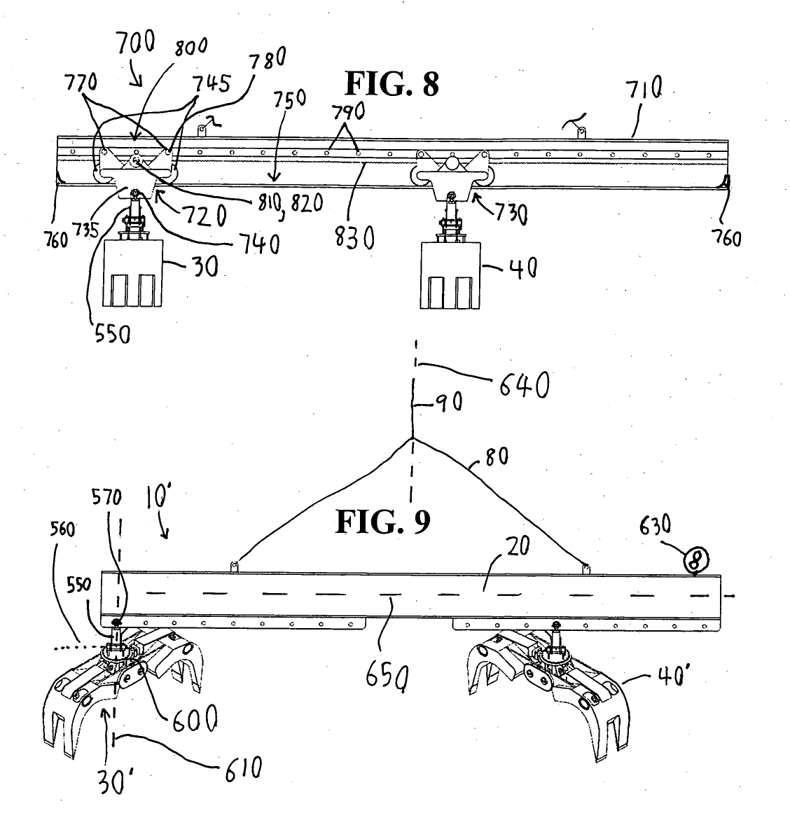

As shown in FIG. 1, the grapples 30, 40 of the grappling system 10 may be selectively moved between discrete mounting holes 120. However, as illustrated by the grappling system 700 illustrated in FIG. 8, the grapples may alternatively be proportionally movable along the frame. The grappling system 700 is generally similar to the grappling system 10 except that a frame 710 with moving trolleys 720, 730 replaces the frame 20 of the grappling system 10. The trolleys 720, 730 are generally similar to each other. Accordingly, only the trolley 720 is described in detail, the description applying equally to the trolley 730. The trolley 720 comprises a trolley frame 735. The trolley frame 735 includes a mounting hole 740 that facilitates mounting of the universal joint 550 and grapple 30 to the trolley frame 735 in the same manner that the universal joint 550 and grapple 30 mount to the mounting holes 120 in the frame 20 of the above-described grappling system 10. Wheels 745 pivotally connect to the trolley frame 735 and engage a track 750 on the frame 710. While only front wheels 745 and a front track 750 are shown, symmetrical rear wheels 745 and a rear track 750 are provided on a rearward side of the trolley frame 735 and frame 710, respectively. The trolley 720 facilitates longitudinal movement of the grapple 30 along the frame 710. Removable detents 760 are provided at the longitudinal ends of the track 750 to prevent the trolleys 720, 730 from disengaging from the track 750 at its longitudinal ends.

As shown in FIG. 8, the trolley 720 also includes a locking mechanism for locking the trolley 720 in a selected longitudinal position along the track 750. One or more pins 770 may be selectively extended through one or more holes 780, respectively, in the trolley frame 735 and selected one or more holes 790, respectively, in the frame 710. The pins 770 may be manually inserted into the holes 780, 790 underwater by a diver or the ROV 580 to lock the position of the grapples 30, 40. Alternatively, an above-water operator may lock the grapples 30, 40 into selected longitudinal positions while the grappling system 700 is above water. According to an alternative embodiment of the present invention, the pins 770 may be remotely actuated. For example, the pins 770 may be attached to remotely operated solenoids so that an above-water operator can selectively actuate the solenoids to lock or unlock the locking mechanism.

The trolley 720 also includes a trolley actuator 800 that selectively moves the trolley 720 along the track 750. The actuator 800 comprises a hydraulic motor 810, a pinion 820 (shown in phantom in FIG. 8) mounted to an output shaft of the motor 810, and a rack 830 attached to the frame 710. The teeth of the rack 830 and pinion 820 mesh such that operation of the motor 810 drives the trolley 720 along the track 750. The motor 810 connects to the power pack 300 via suitable hydraulic lines (not shown). Check valve(s) similar to the check valve 320 may be placed in the hydraulic path(s) between the power pack 300 and the motor 810 to positively lock the motor 810 in a given rotational position. This locking mechanism may be used in addition to or in the lieu of the above-described pin-based locking mechanism. While the illustrated trolley actuator 800 comprises a hydraulic motor 810, a rack 830, and a pinion 820, the trolley actuator 800 may alternatively comprise any other suitable type of actuator without deviating from the scope of the present invention (e.g., linear actuator, electric motor driven actuator, screw-driven actuator, etc.). Moreover, the trolley actuator 800 may be omitted entirely without deviating from the scope of the present invention. In such an embodiment, the trolley is manually movable to a desired longitudinal position by a diver, above-water operator, and/or ROV.

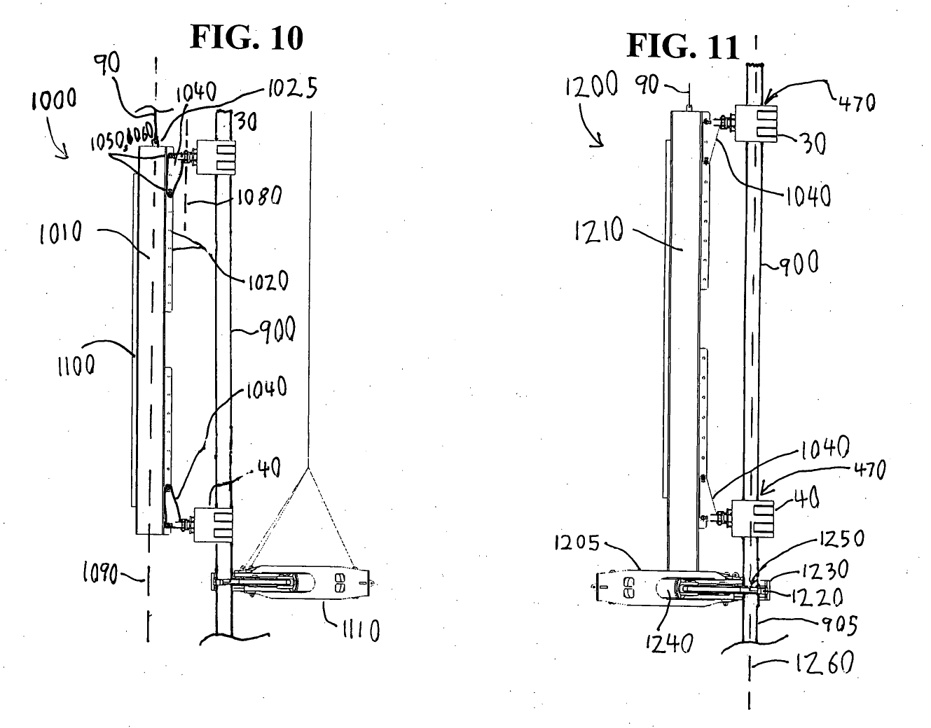

FIG. 10 illustrates a grappling system 1000 according to an alternative embodiment of the present invention. The grappling system 1000 is particularly well suited for gripping vertically-extending work pieces 900. The grappling system 1000 is generally similar to the grappling system 10. Accordingly, a redundant description of redundant features is omitted. The grappling system 1000 includes a frame 1010 that includes a plurality of mounting holes 1020 like the mounting holes 120 of the above-described grappling system 10. The frame 1010 also includes a mounting lug 1025 disposed at a longitudinal end of the frame 1010. The mounting lug 1025 facilitates connection to the cable 90 of the crane 100 such that a longitudinal axis 1090 of the frame 1010 extends substantially vertically.

The grapples 30, 40 connect to the frame 101 via connectors 1040. Each connector 1040 includes two spaced holes 1050 that align with selected two of the holes 1020 of the frame 1010. Pins 1060 extend through the holes 1020, 1050 to rigidly connect the connects to the frame 1010 at a desired longitudinal position on the frame 1010. The grapple 30 pivotally connects to the connector 1040 for pivotal movement relative to the connector 1040 and frame 1010 about an axis 1080 that is parallel to the longitudinal axis 1090 of the frame 1010. The connector 1040 differs from the universal joint 550 of the grappling system 10 because the connector 1040 allows pivotal movement of the grapple 30 about only one axis 1080, which extends in a vertical direction. The connector structurally supports the grapple 30 to prevent the grapple 30 from pivoting/deflecting downwardly relative to the frame 1010.

The frame 1010 includes a counterweight 1100 to counterbalance the weight of the grapples 30, 40 and connectors 1040 relative to the mounting lug 1025. Consequently, the longitudinal axis 1090 of the frame 1010 extends generally vertically. The vertical orientation of the longitudinal axis 1090 facilitates gripping vertically elongated work pieces 900.

Hereinafter, use of the grappling system 1000 is described with reference to FIG. 10. As with the grappling system 10, the crane 100 and ROV 580 move the grappling system 1000 to position the grapples 30, 40 around the vertically extending work piece 900. A shears 1110 or other suitable tool (e.g., torch, explosives, saw, etc.) is then used to sever the work piece 900 from the oil platform 905 (or other remaining object such as an underwater oil or natural gas pipeline). The grappling system 1000 supports the work piece 900 during the severing to reduce stress on the shears 1110 and ensure that the work piece 900 does not fall onto the shears 1110. Once the work piece 900 is severed, the crane 100 moves the grappling system 1000 and gripped work piece 900 to a suitable location.

FIG. 11 illustrates an alternative grappling system 1200, which is generally similar to the grappling system 1000 except that a shears 1205 is mounted to a frame 1210 of the system 1200 below the grapple 40. The shears 1205 include jaws 1220, 1230 that pivotally connect to each other for relative movement between open and closed positions about a vertically extending axis that is parallel to the longitudinal axis of the frame 1210. A hydraulic cylinder 1240 extends between the jaws 1220, 1230 to selectively open and close the jaws 1220, 1230. The cylinder 1240 operatively connects to the power pack 300 via suitable hydraulic line(s). Openings 470 defined between the jaws 210, 220 of the grapples 30, 40 when the grapples 30, 40 are in their released positions and an opening 1250 defined between the jaws 1220, 1230 of the shears 1205 when the shears 1205 is in its open position form a line 1260.

Use of the grappling system 1200 is described with reference to FIG. 11. As in the above-described grappling system 1000, the crane 100, ROV 580, and/or optional thrusters 630 are used to position the grapples of the system 1200 around a vertically extending work piece 900. The grapples 30, 40 then grip the work piece 900. The gripping positions the shears 1205 such that the work piece 900 to be disposed between the open jaws 1220, 1230. While the grapples 30, 40 support the work piece 900, the shears 1205 close to sever the work piece 900 from the remaining oil platform 905 (or other structure). The crane 100 then moves the grappling system 1200 and work piece 900 to a desired location. The grapples 30, 40 are then released to release the work piece 900.

According to various embodiments of the present invention, a plurality of grappling systems 10, 10′, 700, 1000, and/or 1200 may be use in conjunction with each other. Multiple cranes 100 may each support one of the grappling systems 10, 10′, 700, 1000, and/or 1200 to grip different parts of a large work piece 900 (e.g., a work piece that would be too large for a single grappling system 10, 10′, 700, 1000, and/or 1200 and a single crane 100 to manage alone).

According to alternative embodiments of the present invention, the grappling system includes just one grapple 30 or more than two grapples 30 (e.g., 3, 4, 5, etc.). When 3 or more grapples 30 are mounted to a frame, the grapples 30 may be linearly aligned to facilitate gripping of long work pieces 900 (e.g., lengths of horizontally extending natural gas or oil pipelines). Alternatively, the grapples 30 may be aligned in a triangular, square, or other polygonal shape to grip work pieces having irregular or non-linear shapes.

According to alternative embodiments of the present invention, the grappling systems 10, 10′, 700, 1000, and/or 1200 may be used in the construction of structures such as oil platforms. For example, the grappling systems 10, 10′, 700, 1000, and/or 1200 can be used to support components of an oil platform under construction while the components are secured to other components of the oil platform.

While the above-described embodiments are well suited for gripping, moving, and/or positioning components of oil platforms and oil pipelines, the grappling systems 10, 10′, 700, 1000, and/or 1200 may alternatively be used to grip, move, and/or position any other suitable object (e.g., logs, structural components of buildings, bridges, other above water or underwater objects) without deviating from the scope of the present invention. The grappling systems 10, 10′, 700, 1000, and/or 1200 are well suited for gripping and moving heavy elongated objects (e.g., objects that weigh at least 1000 lbs., at least 5,000 lbs., at least 10,000 lbs., at least 20,000 lbs., and/or between 5,000 and 100,000 lbs.; objects that are at least 15 feet long, at least 20 feet long, at least 30 feet long, at least 60 feet long, and/or between 15 and 80 feet long).

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A grappling system comprising:
a frame; and
first and second grapples supported by the frame and spaced from each other, each grapple comprising:
first and second jaws operatively connected with each other for relative movement between a gripping position and a released position, and
an actuator for powered movement of the jaws from their released position to their gripping position,
wherein the actuators of the first and second grapples are independently operable such that the first and second grapples may be independently moved from their released position to their gripping position.

2. The system of claim 1, wherein the actuators of the first and second grapples each comprise at least one hydraulic cylinder.

3. The system of claim 1, wherein the frame comprises a plurality of longitudinally spaced grapple supports, wherein the first and second grapples may be interchangeably supported by any one of a plurality of said plurality of grapple supports.

4. The system of claim 1, wherein the frame comprises an I-beam that extends along a longitudinal axis of the frame.

5. The system of claim 1, wherein:
the frame comprises a spreader bar,
the first and second grapples are supported by the spreader bar, and
the first and second grapples are spaced from each other along a longitudinal axis of the spreader bar.

6. The system of claim 1, further comprising first and second universal joints operatively extending between the first and second grapples, respectively, and the frame.

7. The system of claim 6, wherein the first and second grapples are freely pivotal about their respective universal joints relative to the frame.

8. The system of claim 6, further comprising first and second rotational couplers operatively extending between the first and second grapples, respectively, and the frame.

9. The system of claim 8, wherein the first and second rotational couplers each comprise a rotational coupler actuator for powered rotational actuation of the first and second grapple, respectively, relative to the frame about a respective rotational coupler axis.

10. The system of claim 8, wherein the first and second rotational couplers comprise knock-around rotational couplers.

11. The system of claim 1, further comprising:
a first moving actuator operatively extending between the first grapple and the frame for powered movement of the first grapple relative to the frame; and
a second moving actuator operatively extending between the second grapple and the frame for powered movement of the second grapple relative to the frame.

12. The system of claim 11, wherein operation of the first moving actuator moves the first grapple relative to the frame in a translational direction.

13. The system of claim 12, wherein the translational direction parallels a longitudinal axis of the frame.

14. The system of claim 11, wherein operation of the first moving actuator pivotally moves the first grapple relative to the frame about a pivot axis that is generally perpendicular to a longitudinal axis of the frame.

15. The system of claim 11, wherein operation of the first moving actuator pivotally moves the first grapple relative to the frame about a pivot axis that is generally parallel to a longitudinal axis of the frame.

16. The system of claim 11, wherein the first and second moving actuators are independently operable such that the first and second grapples may be independently moved relative to the frame.

17. The system of claim 1, further comprising a support cable connected to the frame, the support cable supporting the weight of the frame and first and second grapples.

18. The system of claim 17, wherein the frame and first and second grapples are submerged in a body of water.

19. The system of claim 1, further comprising at least one thruster operatively connected to the frame for selective movement of the frame relative to a body of water.

20. The system of claim 1, further comprising a shears supported by the frame, the shears having first and second jaws that are connected to each other for relative movement between open and closed positions.

21. The system of claim 20, wherein openings defined between the jaws of the first and second grapples and the shears when the grapples are in their released positions and the shears is in its open position form a line.

22. The system of claim 1, further comprising:
a grapple insert detachably mounted to the first jaw of the first grapple, the insert reducing a size of an opening formed between the first and second jaws of the first grapple.

23. The system of claim 1, further comprising:
a grapple insert movably mounted to the first jaw of the first grapple, the insert being movable between a retracted position and at least one extended position; and
an insert locking mechanism operatively extending between the insert and the first jaw for selective locking of the insert in the at least one extended position,
wherein, when the first grapple is in the gripping position, the insert is closer to the second jaw when in its extended position than when in its retracted position.

24. The system of claim 23, wherein the insert locking mechanism comprises a hydraulic cylinder.

25. The system of claim 1, further comprising an underwater power pack supported by the frame and operatively connected to the actuator of the first grapple to power the actuator of the first grapple.

26. The system of claim 1, wherein a line extending between the first and second grapples extends in a vertical direction.

27. The system of claim 1, further comprising:
a power supply operatively connected to the actuator of the first grapple to provide gripping power to the actuator of the first grapple; and
a grip locking mechanism constructed and arranged such that when the first grapple is moved into its gripping position, the locking mechanism locks the first grapple in its gripping position even if the first actuator is operatively disconnected from the power supply.

28. The system of claim 27, wherein:
the actuator of the first grapple comprises at least one hydraulic cylinder;
the power supply comprises a hydraulic power supply;
the system further comprises a grapple close hydraulic fluid passageway connecting the hydraulic power supply to the first grapple, wherein pressurization of the grapple close hydraulic fluid passageway actuates the at least one hydraulic cylinder so as to move the jaws of the first grapple toward their gripping position; and
the grip locking mechanism comprises a check valve disposed in the grapple close hydraulic fluid passageway, the check valve permitting fluid flow through the passageway toward the at least one hydraulic cylinder while discouraging fluid flow through the passageway toward the hydraulic power supply.

29. The system of claim 28, further comprising a bleed valve disposed in the grapple close hydraulic fluid passageway between the check valve and the at least one hydraulic cylinder.

30. The system of claim 27, further comprising a release mechanism for selectively disabling the grip locking mechanism.

31. The system of claim 1, further comprising:
first and second power packs operatively connected to the actuators of the first and second grapples, respectively, for independent powering and actuation of the actuators of the first and second grapples.

32. A combination comprising:
a crane with a cable suspended therefrom; and
a grappling system suspended from the cable, the grappling system comprising
a frame supported by the cable, and
first and second grapples supported by the frame and spaced from each other, each grapple comprising
first and second jaws operatively connected with each other for relative movement between a gripping position and a released position, and
an actuator for powered movement of the jaws from their released position to their gripping position.

33. The combination of claim 32, further comprising a vessel floating on a body of water, wherein the crane is supported by the vessel, and wherein the grappling system is submerged in the body of water.

34. A grappling system comprising:
a frame; and
first and second grapples supported by the frame and spaced from each other, each grapple comprising:
first and second jaws operatively connected with each other for relative movement between a gripping position and a released position, wherein opposing inner surfaces of the first and second jaws, respectively, form depressions that bulge away from the opposing jaw, and
an actuator for powered movement of the jaws from their released position to their gripping position.

35. The grappling system of claim 34, further comprising a support cable connected to the frame, the support cable supporting the weight of the frame and first and second grapples.

36. A method of manipulating an underwater object, the method comprising:
submerging a grappling system in a body of water, the grappling system comprising
a first grapple that comprises
first and second jaws movably connected to each other for relative movement between a gripping position and a released position, and
an actuator for powered movement of the jaws from their released position to their gripping position;
gripping the object with the first grapple; and
moving the first grapple so as to move the object.

37. The method of claim 36, wherein:
the grappling system further comprises
a frame; and
a second grapple, the first and second grapples being supported by the frame and spaced from each other, the second grapple comprising
first and second jaws movably connected to each other for relative movement between a gripping position and a released position, and
an actuator for powered movement of the jaws from their released position to their gripping position; and
wherein the method further comprises gripping the object with the second grapple.

38. The method of claim 37, wherein:
the first and second grapples are supported by the frame via spaced apart first and second connections, respectively, and
the method further comprises changing a distance between the first and second connections based on at least one physical parameter of the object.

39. The method of claim 37, further comprising:
suspending the frame from a cable of a crane; and
moving the object that is gripped by the grapples via operation of the crane.

40. The method of claim 37, further comprising:
severing a portion of the object that is gripped by the first and second grapples from an additional portion of the object; and
moving the severed portion of the object by moving the grappling system.

41. The method of claim 40, further comprising:
moving the grapples into their released positions to release the severed portion of the object.

42. The method of claim 40, wherein moving the severed portion comprises raising a cable from which the grappling system is suspended.

43. The method of claim 40, wherein the object comprises a portion of a decommissioned oil platform.

44. The method of claim 37, further comprising:
after gripping the object with the first grapple and before gripping the object with the second grapple, moving the second grapple so as to position object between the jaws of the second grapple.

45. The method of claim 37, further comprising:
before gripping the object with the first grapple, moving the first grapple so as to position the object between the jaws of the first grapple.

46. The method of claim 45, wherein moving the first grapple comprises using a remotely operated vehicle to move the first grapple.

47. The method of claim 45, wherein the grappling system comprises a thruster supported by the frame, wherein moving the first grapple comprises operating the thruster so as to move the first grapple.

48. The method of claim 36, wherein the actuator comprises at least one hydraulic cylinder.

49. The method of claim 36, wherein the underwater object comprises a piece of a decommissioned oil platform.

50. The method of claim 36, wherein the underwater object weighs at least 5,000 pounds.

51. The method of claim 36, wherein the underwater object is at least 20 feet long.
